(19) United States
(12) Patent Application Publication
(10) Pub. No.: US 2003/0099362 A1
(43) Pub. Date: May 29, 2003

(54) Method and apparatus for WEP key management and propagation in a wireless system

(76) Inventor: Doug Rollins, Nampa, ID (US)

Correspondence Address: DICKSTEIN SHAPIRO MORIN & OSHINSKY LLP, 2101 L STREET NW, WASHINGTON, DC, 20037-1526, US

(21) Appl. No.: 09/993,495

(22) Filed: Nov. 27, 2001

(51) Int. Cl. H04L 9/00

(52) U.S. Cl. 380/278; 380/270

(57) ABSTRACT

A method and apparatus for encryption key management and propagation in a wireless system is disclosed. Encryption keys at each wireless station are stored on a wireless network communication devices at each wireless station. For encryption key updating, a management station randomly generates a new encryption key and propagates it to a wired device in a wired network which can receive a wireless network communications device and update its encryption key.

### FIELD OF THE INVENTION

The present invention relates to generally to network security, and, more particularly to a method and apparatus for encryption key management and propagation in a wireless system.

### BACKGROUND OF THE INVENTION

In a wired LAN, data transmissions are generally regarded as secure. Only those stations physically connected to the wire can receive the LAN traffic. For this reason, significant security precautions are generally not taken to protect the privacy of data transmissions within a LAN.

A network with wireless stations is not as secure. When data is transmitted to a wireless station, any station within range can eavesdrop on the transmission. The connection of a single wireless link (without any privacy protection) may seriously degrade the security level of the wired LAN.

Despite the security issues involved in implementing wireless stations, there are many advantages. A company can gain significant advantages by providing wireless connectivity to stations, such as, for example, automatic machinery or equipment that requires rapid deployment within a local area. The stations can be portable, hand-held or mounted on moving vehicles.

In an effort to preserve network security while using wireless stations, the IEEE has devised Wired Equivalency Privacy (“WEP”). WEP is a cryptographic confidentiality algorithm that can be used to provide data confidentiality that is subjectively equivalent to the confidentiality of a wired local area network that does not use cryptographic techniques to enhance privacy.

An example of a wireless network is shown in FIG. 1. Wireless station 100 comprises a wireless network communications device 103, a microprocessor 101 and a data storage area 102. Wireless communications device 103 can be a wireless network interface card. Data storage area 102 stores the operating system and the support application for wireless station 100. An encryption key is stored within the support application.

Wired station 110 comprises a network communications device 113, a microprocessor 111 and a data storage area 112. Data storage area 112 stores the operating system and management application for wired station 110. Access point 120 is physically connected to wired station 110. Access point 120 is a bridge between the Ethernet network and the wireless network. These devices are well known in the art.

The process for updating encryption keys in a wireless network, such as that shown in FIG. 1, implementing WEP is shown in FIG. 2. The process begins when the network administrator selects a new encryption key at segment 200. IEEE 802.11x standard suggests a 40-bit or 128-bit encryption key, however, any convenient length may be used. The network administrator then propagates the new encryption key to access point 120. This can be accomplished one of two ways. If the vendor supplies a management application that supports automatic propagation to access points, then that may be used. If the vendor supplied management application does not provide the ability to automatically propagate new encryption keys to access points, the network administrator must manually enter the new encryption key at each access point. This entails writing the encryption key down and then manually entering it into the access point management application.

Once the encryption key at access point 120 is updated, no wireless network traffic can be decrypted by wireless station 100 until the encryption key at wireless station 100 is updated to match the updated encryption key at access point 120. In order to update the encryption key at wireless station 100 at segment 210, the network administrator must manually enter the new encryption key at wireless station 100. The encryption keys are stored in the software associated with wireless network communications device 103. As a result, the network administrator must physically access wireless station 100, start the operating system, open wireless communications device 103's support application and manually enter the WEP key at segment 210. This process must then be repeated for each wireless station.

Due to the cumbersome nature of manually changing the encryption keys at every wireless station, network administrators are reluctant to update encryption keys on a regular basis. When they do update the encryption key, it is a time-consuming task.

A quick, easy and secure method and apparatus for updating encryption keys in a wireless network is desirable.

### SUMMARY OF THE INVENTION

The present invention mitigates the problems associated with the prior art and provides a unique method and apparatus for encryption key management and propagation in a wireless system.

In accordance with an exemplary embodiment of the present invention, an encryption key is stored in a removable wireless network communications device in each wireless station. When an encryption key is to be updated, the wireless network communications device card is removed from the wireless station and inserted into a card tray connected to a wired portion of the network. A management station randomly generates a new encryption key and propagates it to all access points and to one or more card trays. The card trays may be conventional personal computer card trays, e.g. PCMCIA or other PC card trays. Once the encryption key is updated at each access point and the one or more PC card trays and the encryption key in each of the wireless network communications devices is updated. The wireless network communications devices having updated encryption keys may then be removed from the card trays and reinserted into the wireless stations.

### BRIEF DESCRIPTION OF THE DRAWINGS

The above and other features and advantages of the invention will be more readily understood from the following detailed description of the invention which is provided in connection with the accompanying drawings.

FIG. 1 is a block diagram of a wireless network;

FIG. 2 is a flowchart of the process of updating the encryption keys in a wireless network in the prior art;

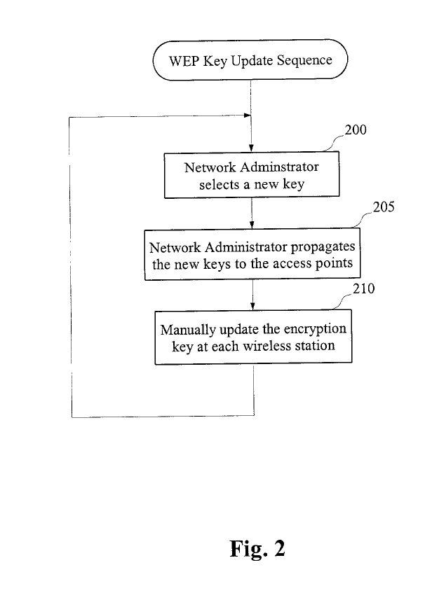

FIG. 3 is a flowchart of an exemplary embodiment of the present invention; and

FIG. 4 is a block diagram of a wireless network implementing an exemplary embodiment of the present invention.

### DETAILED DESCRIPTION OF PREFERRED EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to make and use the invention, and it is to be understood that structural changes may be made and equivalent structures substituted for those shown without departing from the spirit and scope of the present invention.

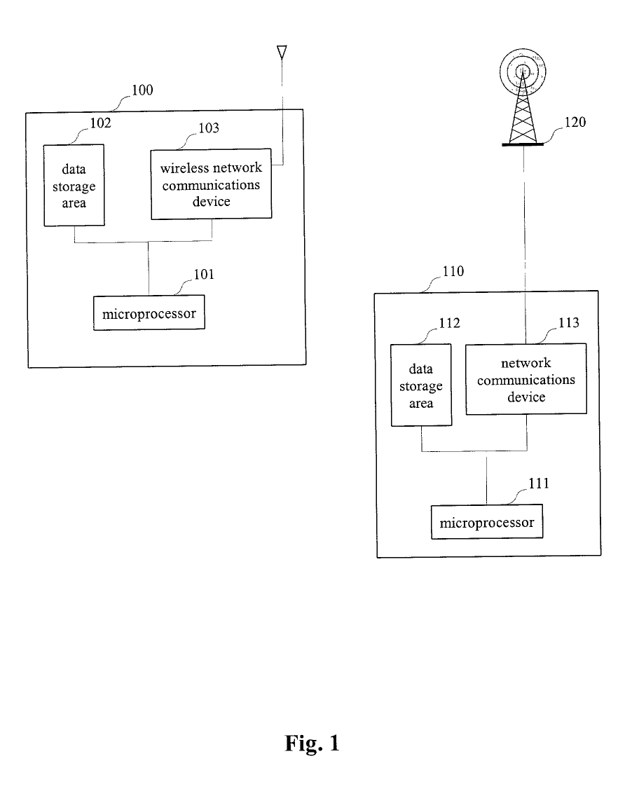

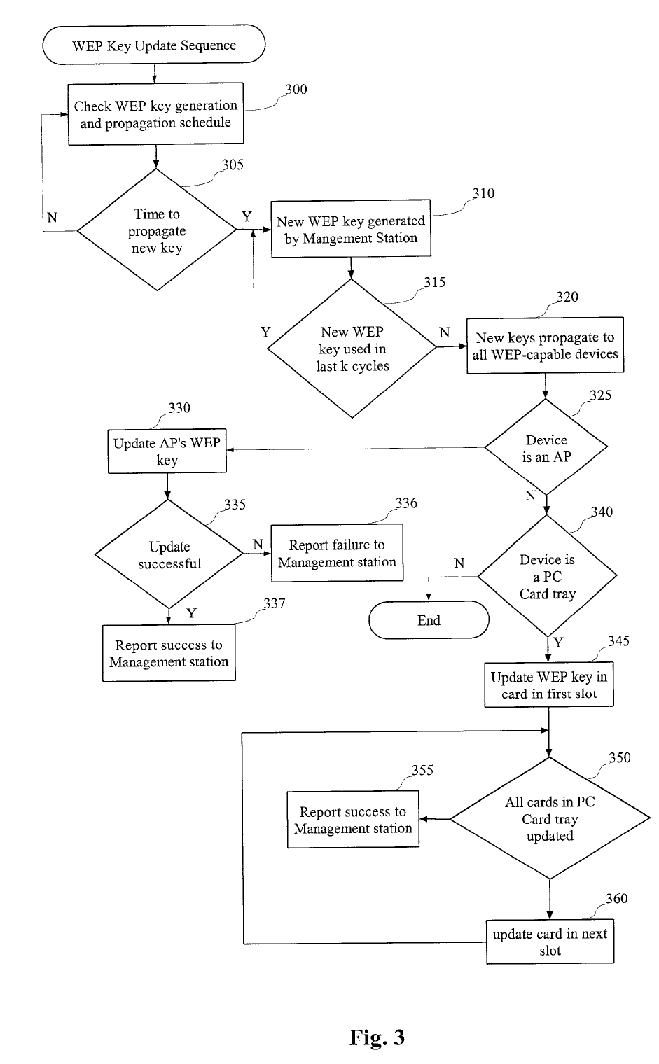

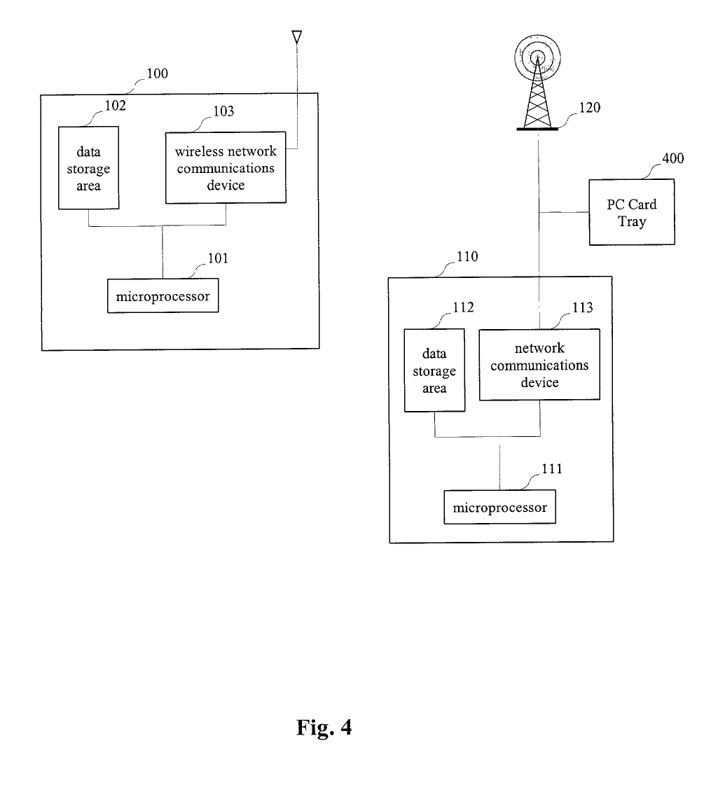

FIG. 3 shows an exemplary embodiment of the present invention implemented on the network shown in FIG. 4. FIG. 4 is identical to FIG. 1 except for the addition of a card tray 400 (“PC card tray”). The card tray may receive any type of conventional computer card, but for purposes of simplifying discussion, it will be assumed that the network communications devices are provided on a PCMCIA card and that the card tray 400 receives such cards. PCMCIA (Personal Computer Memory Card International Association) established standards for memory and I/O devices for personal computers. PC card tray 400 has a plurality of slots each of which can receive an inserted wireless network communications device 103 that meets the PCMCIA standards. When wireless network communications device 103 is inserted into a slot of PC card tray 400, and the PC card tray 400 receives a new encryption key, PC card tray 400 accesses the encryption key stored in wireless communications device 103, erases the old encryption key and stores the updated encryption key. Additionally, if a PC card tray 400 has already received a new encryption key when wireless communications device 103 is inserted, PC card tray 400 can then access the encryption key stored in wireless communications device 103, erase the old encryption key and store the updated encryption key.

Referring to FIG. 3, in an exemplary embodiment of the present invention, management station 110 checks the encryption key generation and propagation schedule at segment 300. If it is not a scheduled time to propagate a new encryption key, as determined at processing segment 305, management station 110 returns to segment 300. If management station 110 determines that it is time to propagate a new key according to the encryption key generation and propagation schedule at processing segment 305, management station 110 generates a new encryption key at segment 310.

The encryption key generation and propagation schedule can be determined by the network administrator. Encryption key updates can be set to take place on specific days at specific times, at specified intervals (e.g. every Monday), randomly or whenever a network administrator wants to change the encryption key. Once the network administrator determines how often to update the encryption keys, the network administrator can set the system to either automatically propagate the new encryption keys on schedule or to alert the network administrator to propagate the new encryption key.

Scheduled encryption key updates has several advantages. First, network security will not be compromised by extended periods of time using the same encryption key. Second, since management station 110 is generating the encryption key, rather than the network administrator, the encryption key is randomly generated. A randomly generated encryption key provides for greater security than a manually chosen one.

Security can be further enhanced if the same encryption key is not frequently reused. Thus, the system may also be set to prevent re-use of encryption keys. Accordingly, once a new encryption key is generated at segment 310, management station 110 verifies that the randomly generated encryption key is not identical to any of the k encryption keys that were previously used at processing segment 315. The number of previous encryption keys that each new encryption key is checked against can be set by the network administrator at management station 110. If the encryption key randomly generated at segment 310 matches one of the previous k encryption keys used, as determined at processing segment 315, that encryption key is discarded and management station 110 returns to segment 310 to randomly generate a new encryption key.

After management station 110 randomly generates an encryption key that is not identical to any of the previous k encryption keys, the new encryption key is propagated to all WEP-enabled devices at segment 320. Access points 120 and PC card trays 400 all store the new encryption key.

In a preferred embodiment of the present invention, there are two types of encryption key capable devices. First, there are the access points. Access points are bridges between the Ethernet network and the wireless network. These devices are well known in the art. Second, there are PC card trays. The PC card trays are connected to the wired Ethernet and can have multiple PC cards inserted simultaneously for encryption key updating. A crucial improvement of the present invention is that the encryption key is stored in wireless communications device 103 rather than in data storage area 102. As a result, wireless communications device 103 can be removed from wireless station 100 and inserted into PC card tray 400 to be updated. Once wireless communications device 103 is inserted into PC card tray 400 and the PC card tray 400 receives a new encryption key, the PC card tray 400 enables access to the encryption key stored in wireless communications device 103, the new updated encryption key is stored in wireless communications device 103. PC card trays can be connected to the wired Ethernet at any convenient location.

By allowing wireless communications device 103 to be updated by placing it in PC card tray 400, greater network security and reliability is achieved. First, since the encryption key is not written down and entered manually, there is no chance of the network administrator making an error while typing in the new encryption key. Second, since not even the network administrator knows what the encryption key is, the only way to obtain the encryption key is by gaining physical access to the network. Third, the network administrator does not have to physically access each wireless station 100. A technician, or even the user, can remove network communications device 103 from wireless station 100 and insert it into PC card tray 400. There can be many PC card trays connected to the wired network and placed at convenient locations so that the inconvenience is minimized.

If the device being updated is an access point, as determined at processing segment 325, then the encryption key is updated at segment 330. If the update is successful, as determined at processing segment 335, success is reported to management station 110 at segment 337. If the update is not successful, as determined at processing segment 335, failure is reported to management station 110 at segment 336. Management station 110 can then alert the network administrator of the failure so that the problem can be corrected. If the device is not an access point, as determined at processing segment 325 and if the device is not a PC card tray 400, as determined a processing segment 340, e.g. it is a wired station of the wired network, the process ends.

If the device is a PC card tray 400, as determined at processing segment 340, the encryption key of the wireless communications device 103 in the first slot of PC card tray 400 is updated at segment 345. The encryption key stored in wireless communications device 103 can also be updated after the new encryption key has been propagated to the network by inserting it into PC card tray 400. If the encryption keys in all network communications devices 103 in PC card tray 400 have not been updated, as determined at processing segment 350, the network communications device 103 in the next slot of PC card tray 400 is updated at segment 360. If the encryption keys in all network communications devices 103 in PC card tray 400 have been updated, as determined at processing segment 350, success is reported to management station 110 at segment 355.

While the invention has been described with reference to exemplary embodiments various additions, deletions, substitutions, or other modifications may be made without departing from the spirit or scope of the invention. Accordingly, the invention is not to be considered as limited by the foregoing description, but is only limited by the scope of the appended claims.

What is claimed as new and desired to be protected by Letters Patent of the United States is:

1. A method of updating an encryption key in a wireless network, said method comprising:
separating a communication device containing an encryption key from a wireless station of said network;
connecting said removed communications device to a wired portion of said network which contains an encryption key generator;
replacing an existing encryption key in said communications device with a new encryption key from said generator using a communication over said wired portion of said network; and
reconnecting said communications device containing said new encryption key with wireless station of said network.

2. A method as in claim 1, wherein said new encryption key is generated at user-defined intervals.

3. A method as in claim 1, wherein said new encryption key is generated on user-specified days.

4. A method as in claim 1, wherein said key generator generates a first new encryption key;
compares said new encryption key to the previous k encryption keys used in said network; and
generates a second new encryption key if said first new encryption key matches any of said k previously used encryption keys.

5. A method as in claim 5, wherein k is a user-defined number of previously used encryption keys.

6. A method as in claim 1, wherein said network communication device is configured on a plug-in card and is connected to said network by inserting said network communications device into a card tray.

7. A method as in claim 6, wherein a plurality of network communications devices can be inserted into said card tray simultaneously.

8. A wireless network comprising:
a wired station connected to a wired network, said wired station comprising:
an encryption key generator for generating an encryption key; and
a wired network communications device for transmitting said encryption key over said wired network;
a wireless station wirelessly connected to said wired network, said wireless station comprising:
a wireless network communications device containing an encryption key, said wireless network communications device being disconnectable from said wireless station and connectable to said wired network to receive and store as a new encryption key, an encryption key transmitted over said wired network by said wired network communications device.

9. A wireless network as in claim 8, wherein said new encryption key is a randomly generated encryption key

10. A wireless network as in claim 8, wherein said new encryption key is generated by said generator and transmitted by said wired network communications device at user-defined intervals.

11. A wireless network as in claim 8, wherein when a newly generated encryption key is the same as one of k previously used encryption keys, said encryption key generator generates a new encryption key.

12. A wireless network as in claim 11, wherein k is a user-defined number.

13. A wireless network as in claim 8, further comprising a plurality of access points.

14. A wireless network as in claim 8, further comprising a card tray connected to said wired network, said wireless network communications device being connected to said wired network by insertion of said wireless network communications device into said card tray.

15. A wireless network wireless station comprising:
a wireless network communications device for conducting wireless communications with a wired network, said wireless network communications device being removable from said station and storing an updateable encryption key used in conducting encrypted wireless communications, said removable wireless network communications device being connectable to a wired network to receive and store a new encryption key.

16. A wireless station as in claim 15, wherein said wireless network communications device is adapted to be connected to a wired network by being insertable into a card tray connected to said wired network.

17. A wireless network communications device comprising:
a removable wireless communications network card adapted to be connected to and disconnected from a wireless station card interface;
a storage area said network card which stores an updateable encryption key for use in conducting encrypted wireless network communications, said encryption key being updateable when said card is connected to a wired network card interface which supplies a new encryption key.

18. A wireless network communications card as in claim 17, wherein said card interface for providing a new encryption key is a PCMCIA card interface.

19. A wireless network communications card as in claim 18, wherein said PCMCIA card interface is provided at a PCMCIA card tray.

20. An encryption key programming system comprising:
an encryption key generator connected to a wired network;
a programming device connected to said wired network for receiving over a wire connection an encryption key from said generator, said programming device being adapted to receive a wireless network communications device and storing said received encryption key in said wireless network communications device.

21. An encryption key programming system as in claim 20, wherein said encryption key generator generates a random encryption key.

22. An encryption key programming system as in claim 20, wherein said encryption key generator generates a new encryption key at user-defined intervals.

23. An encryption key programming system as in claim 20, wherein said encryption key generator generates a new encryption key on user-specified days.

24. An encryption key programming system as in claim 20, wherein said encryption key generator generates a first new encryption key, compares said new encryption key to the previous k encryption keys used in said network and generates a second new encryption key if said first new encryption key matches any of said k previously used encryption keys;

25. An encryption key programming system as in claim 20, wherein k is a user-defined number of previously used encryption keys.

26. An encryption key programming system as in claim 20, further comprising a card tray connected to said programming device, said wireless communications device being received by said programming device by insertion of said wireless communications device into said card tray.
